(19) United States
(12) Patent Application Publication
(10) Pub. No.: US 2013/0177751 A1
(43) Pub. Date: Jul. 11, 2013

(54) ANTI-REFLECTIVE COATING LAYER AND MANUFACTURING METHOD THEREOF

(71) Applicants: Byung-Chul OH, Yongin-City (KR); Chung-Soo HA, Yongin-City (KR); Dong-Hwan LEE, Yongin-City (KR); Sang-Wook LEE, Yongin-City (KR); Do-Hyun SHEEN, Seoul (KR); Hee-Shin LEE, Incheon (KR)

(72) Inventors: Byung-Chul OH, Yongin-City (KR); Chung-Soo HA, Yongin-City (KR); Dong-Hwan LEE, Yongin-City (KR); Sang-Wook LEE, Yongin-City (KR); Do-Hyun SHEEN, Seoul (KR); Hee-Shin LEE, Incheon (KR)

(21) Appl. No.: 13/659,991

(22) Filed: Oct. 25, 2012

(30) Foreign Application Priority Data
Jan. 9, 2012 (KR) 10-2012-0002633

(51) Int. Cl. B32B 33/00; B05D 5/06; B32B 7/00

(52) U.S. Cl. CPC B32B 33/00; B32B 7/00; B05D 5/061
USPC 428/216; 428/411.1; 428/702; 428/448; 428/336; 427/162

(57) ABSTRACT

An anti-reflective coating layer with transparent non-chromaticity includes a substrate and an anti-reflection layer, the anti-reflection layer including a plurality of high reflective layers and a plurality of low reflective layers alternately disposed on the substrate, a reflectance of the anti-reflection layer being 0.01% to 1.2% throughout a wavelength range of visible ray.

### CROSS-REFERENCE TO RELATED APPLICATION

This application claims priority to and the benefit of Korean Patent Application No. 10-2012-0002633 filed in the Korean Intellectual Property Office on Jan. 9, 2012, the entire contents of which are incorporated herein by reference.

### BACKGROUND

1. Field

The described technology relates generally to an anti-reflective coating layer and a manufacturing method thereof.

2. Description of the Related Art

In general, it is not difficult to view a screen of a display device indoors, however, when viewing a screen of a display device outdoors, in the presence of external light, visibility is deteriorated by brightness of the external light and readability is deteriorated by reflection from the screen.

### SUMMARY

One or more embodiments may provide an anti-reflective coating layer with transparent non-chromaticity, including a substrate, and an anti-reflection layer, the anti-reflection layer including a plurality of high reflective layers and a plurality of low reflective layers alternately disposed on the substrate, a reflectance of the anti-reflection layer being 0.01% to 1.2% throughout a wavelength range of visible ray.

The plurality of high reflective layers and the plurality of low reflective layers alternately disposed on the substrate may include a first high reflective layer on the substrate, a first low reflective layer on the first high reflective layer, a second high reflective layer on the first low reflective layer, a second low reflective layer on the second high reflective layer, a third high reflective layer on the second low reflective layer, and a third low reflective layer on the third high reflective layer.

A thickness of the first high reflective layer may be 14.9 nm to 17.5 nm, a thickness of the first low reflective layer may be 31.9 nm to 37.5 nm, a thickness of the second high reflective layer may be 56.5 nm to 66.3 nm, a thickness of the second low reflective layer may be 8.6 nm to 10.2 nm, a thickness of the third high reflective layer may be 51.4 nm to 60.4 nm, and a thickness of the third low reflective layer may be 80.0 nm to 94.0 nm.

The first high reflective layer, the second high reflective layer, and the third high reflective layer may have a refractive index of more than 1.9.

The first high reflective layer, the second high reflective layer, and the third high reflective layer may include titanium oxide and lanthanum oxide.

The first low reflective layer, the second low reflective layer, and the third low reflective layer may have a refractive index of less than 1.6.

The first low reflective layer, the second low reflective layer, and the third low reflective layer may include silicon dioxide.

The anti-reflective coating layer may further include an anti-fingerprint layer on the third low reflective layer.

A thickness of the anti-fingerprint layer may be 18.4 nm to 21.6 nm.

One or more embodiments may provide a method of manufacturing an anti-reflective coating layer, the method including forming an anti-reflection layer by alternately depositing a plurality of high reflective layers and a plurality of low reflective layers on a substrate; and controlling a thickness of the high reflective layers and the low reflective layers by selectively using a crystal thickness control method (QCM) and an optical thickness control method (OPM).

Alternately depositing the plurality of high reflective layers and the plurality of low reflective layers on the substrate may include forming a first high reflective layer on the substrate, forming a first low reflective layer on the first high reflective layer, forming a second high reflective layer on the first low reflective layer, forming a second low reflective layer on the second high reflective layer, forming a third high reflective layer on the second low reflective layer, and forming a third low reflective layer on the third high reflective layer.

Controlling the thickness of the high reflective layers and the low reflective layers may include using the optical thickness control method (OPM) to maintain a thickness of more than λₚ/4n in the high reflective layer or a thickness of more than λp/4n in the low reflective layer, where λₚ=a reference wavelength of a control light irradiated in the optical thickness control method (OPM), and n=a refractive index of the high reflective layer or the low reflective layer.

The crystal thickness control method (QCM) may be used to maintain a thickness of less than λₚ/4n in the high reflective layer or the low reflective layer.

The thickness of the first high reflective layer may be 14.9 nm to 17.5 nm, the thickness of the first low reflective layer may be 31.9 nm to 37.5 nm, the thickness of the second high reflective layer may be 56.5 nm to 66.3 nm, the thickness of the second low reflective layer may be 8.6 nm to 10.2 nm, the thickness of the third high reflective layer may be 51.4 nm to 60.4 nm, and the thickness of the third low reflective layer may be 80.0 nm to 94.0 nm.

The optical thickness control method (OPM) may be used to maintain a thickness of more than 51 nm in the high reflective layer when the reference wavelength is 430 nm, and the crystal thickness control method (QCM) may be used to maintain a thickness of less than 51 nm in the high reflective layer when the reference wavelength is 430 nm.

The optical thickness control method (OPM) may be used to maintain a thickness of more than 73 nm in the low reflective layer when the reference wavelength is 430 nm, and the crystal thickness control method (QCM) may be used to maintain a thickness of less than 73 nm in the low reflective layer when the reference wavelength is 430 nm.

The thicknesses of the first high reflective layer, the first low reflective layer, and the second low reflective layer may be controlled by the crystal thickness control method (QCM), and the thicknesses of the second high reflective layer, the third high reflective layer, and the third low reflective layer may be controlled by the optical thickness control method (OPM).

The method may further include forming an anti-fingerprint layer on the third low reflective layer.

The anti-fingerprint layer may be formed with a thickness of 18.4 nm to 21.6 nm.

The thickness of the anti-fingerprint layer may be controlled by the crystal thickness control method (QCM).

### BRIEF DESCRIPTION OF THE DRAWINGS

FIG. 1 illustrates a cross-sectional view of an anti-reflective coating layer according to an exemplary embodiment.

FIG. 2 illustrates a graph showing reflectance of a color of an anti-reflective coating layer according to an exemplary embodiment and reflectance of a color of a conventional blue anti-reflective coating layer.

FIG. 3 illustrates a view of sequential stages in a manufacturing method of an anti-reflective coating layer according to an exemplary embodiment.

FIG. 4 illustrates a transmittance graph of an anti-reflective coating layer according to an exemplary embodiment.

FIG. 5 illustrates a reflectance graph of an anti-reflective coating layer according to an exemplary embodiment.

### DETAILED DESCRIPTION

The embodiments will be described more fully hereinafter with reference to the accompanying drawings, in which exemplary embodiments of the invention are shown. As those skilled in the art would realize, the described embodiments may be modified in various different ways, all without departing from the spirit or scope of the embodiments. Like reference numerals designate like elements throughout the specification. As the size and thickness of the respective structural components shown in the drawings are arbitrarily illustrated for explanatory convenience, the embodiments are not necessarily limited to that which is illustrated.

In the drawings, the thickness of layers, films, panels, regions, etc., are exaggerated for clarity, better understanding, and convenience in description. It will be understood that when an element such as a layer, film, region, or substrate is referred to as being “on” another element, it can be directly on the other element or intervening elements may also be present.

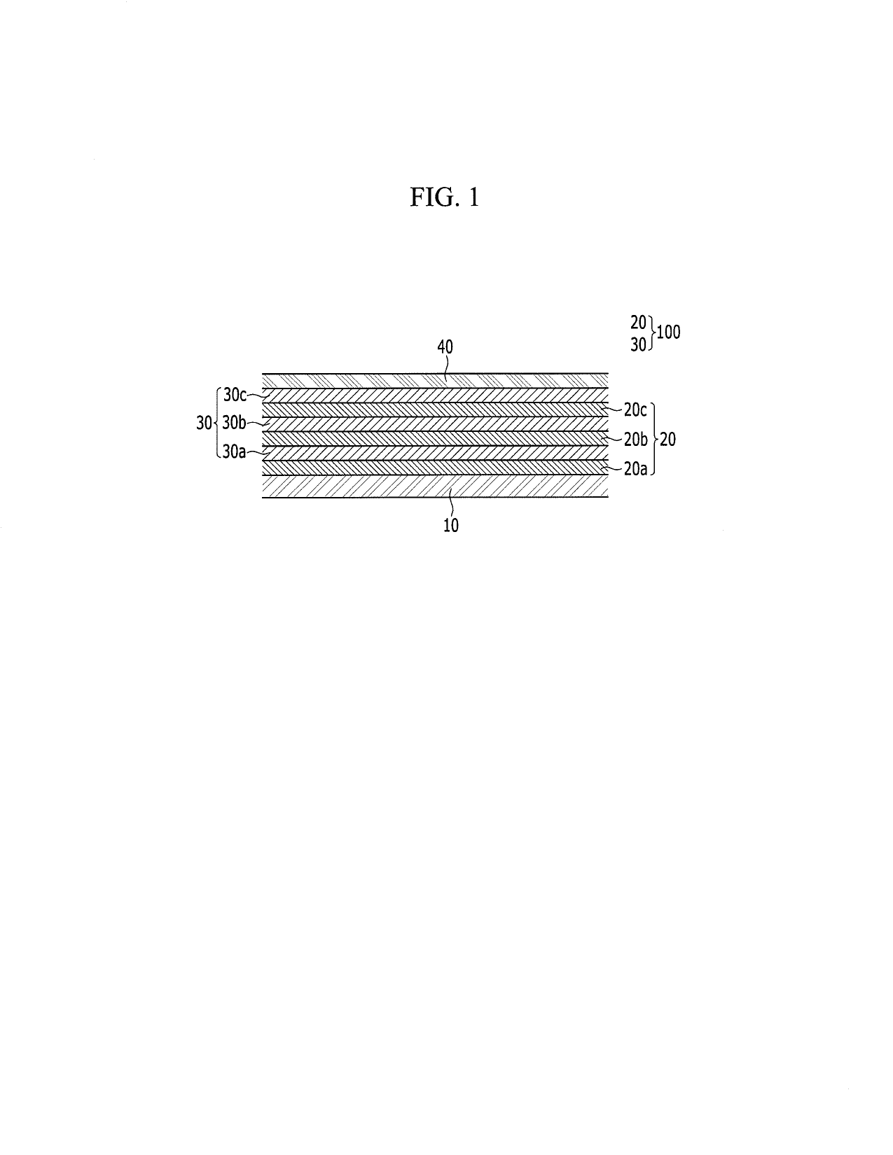

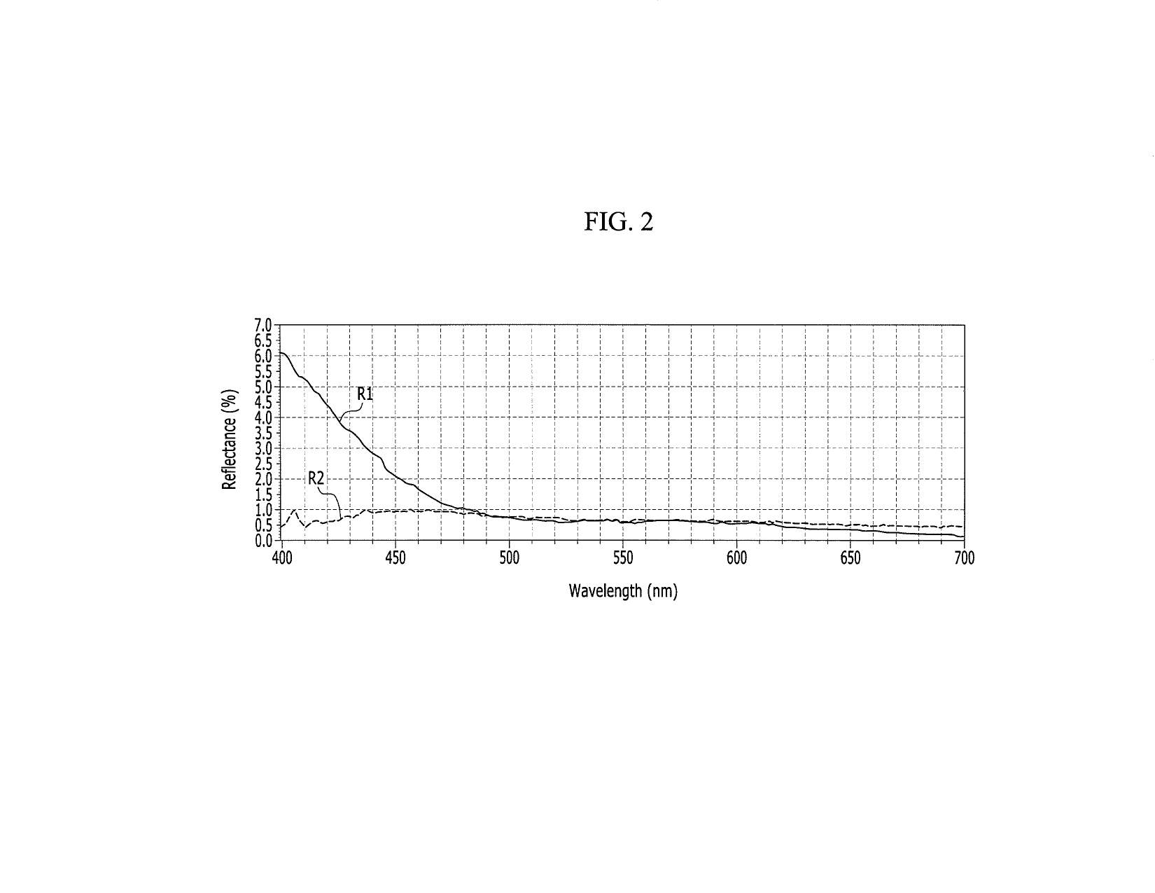

An anti-reflective coating layer according to an exemplary embodiment is described with reference to FIG. 1 and FIG. 2.

FIG. 1 illustrates a cross-sectional view of an anti-reflective coating layer according to an exemplary embodiment.

As shown in FIG. 1, an anti-reflective coating layer according to an exemplary embodiment includes a substrate 10 and an anti-reflection layer 100. The anti-reflection layer 100 may include a plurality of high reflective layers 20 and a plurality of low reflective layers 30 alternately formed on the substrate 10. The plurality of high reflective layers 20 may include a first high reflective layer 20a, a second high reflective layer 20b, and a third high reflective layer 20c. The plurality of low reflective layers may include a first low reflective layer 30a, a second low reflective layer 30b, and a third low reflective layer 30c. In the embodiment shown, three high reflective layers 20 and three low reflective layers 30 are alternately formed. However, the plurality of high reflective layers 20 and the plurality of low reflective layers 30 may include any suitable number of reflective layers.

The substrate 10 is attached to a display device such as an organic light emitting diode (OLED) display. The substrate includes a plate of transparent tempered glass or a high molecule material.

The anti-reflection layer 100 includes the first high reflective layer 20a formed on the substrate 10, the first low reflective layer 30a formed on the first high reflective layer 20a, the second high reflective layer 20b formed on the first low reflective layer 30a, the second low reflective layer 30b formed on the second high reflective layer 20b, the third high reflective layer 20c formed on the second low reflective layer 30b, and the third low reflective layer 30c formed on the third high reflective layer 20c.

The first high reflective layer 20a, the second high reflective layer 20b, and the third high reflective layer 20c may be high reflective materials including, e.g., a titanium oxide and a lanthanum oxide.

The first low reflective layer 30a, the second low reflective layer 30b, and the third low reflective layer 30c may be low reflective materials including silicon dioxide (SiO₂).

The thickness of the first high reflective layer 20a may be 14.9 nm to 17.5 nm, the thickness of the first low reflective layer 30a may be 31.9 nm to 37.5 nm, the thickness of the second high reflective layer 20b may be 56.5 nm to 66.3 nm, the thickness of the second low reflective layer 30b may be 8.6 nm to 10.2 nm, the thickness of the third high reflective layer 20c may be 51.4 nm to 60.4 nm, and the thickness of the third low reflective layer 30c may be 80.0 nm to 94.0 nm.

The thickness of the entire region of the first high reflective layer 20a, the second high reflective layer 20b, and the third high reflective layer 20c is uniform, such that the refractive index of the entire region of the first high reflective layer 20a, the second high reflective layer 20b, and the third high reflective layer 20c is uniform. Consequently, the reflectance of the first high reflective layer 20a, the second high reflective layer 20b, and the third high reflective layer 20c for the color is uniform. The refractive index of the first high reflective layer 20a, the second high reflective layer 20b, and the third high reflective layer 20c may be more than 1.9.

The thickness of the entire region of the first low reflective layer 30a, the second low reflective layer 30b, and the third low reflective layer 30c is uniform, such that the refractive index of the entire region of the first low reflective layer 30a, the second low reflective layer 30b, and the third low reflective layer 30c is uniform. Consequently, the reflectance of the first low reflective layer 30a, the second low reflective layer 30b, and the third low reflective layer 30c for the color is uniform. The refractive index of the first low reflective layer 30a, the second low reflective layer 30b, and the third low reflective layer 30c may be less than 1.6.

FIG. 2 illustrates a graph of reflectance for a color of an anti-reflective coating layer according to an embodiment and reflectance for a color of a general blue anti-reflective coating layer.

As shown in FIG. 2, the reflectance R1 of the general blue anti-reflective coating layer is increased in the blue wavelength region at less than 450 nm, however the reflectance R2 of the anti-reflective coating layer according to an embodiment is within a range of 0.01% to 1.2% in most of the wavelength region, particularly the entire visible ray wavelength region, such that the reflectance R2 is uniform.

As described above, the reflectance R2 of the anti-reflective coating layer according to an embodiment is uniform in the described wavelength region, such that the anti-reflective coating layer may not realize color, and may, thereby, realize transparent non-chromaticity.

Accordingly, embodiments may provide the anti-reflective coating layer with transparent non-chromaticity and without an arbitrary color. Reflectance of the anti-reflective coating layer may be minimized. As such, visibility of a screen of a display device may not be distorted by an arbitrary color or reflection, and readability may be improved outdoors as well as indoors.

Once the display device has the anti-reflective coating layer according to an exemplary embodiment attached thereto, sufficient visibility and low luminance may be provided such that an amount of power consumption of the battery may be reduced. Consequently, the display device may be used for a long time. Accordingly, it may be more convenient to use the display device according to an embodiment rather than using a general display device. Further, because less power may be consumed by the battery, the display device having the anti-reflective coating layer according to an embodiment may be economical and environmentally friendly.

An anti-fingerprint layer 40 may be formed on the third low reflective layer 30c. The anti-fingerprint layer 40 may be made of at least one of an organic material, an inorganic material, and a polymer, and materials having different hardnesses may be mixed or deposited. As one example, the anti-fingerprint layer 40 may include fluorine (F). Consequently, the anti-reflection layer 100 may be simultaneously protected from an interference applied to the anti-reflection layer 100 from the outside, e.g., residue from physical contact with an external object or substance, and adherence of external contamination materials. For example, the anti-fingerprint layer 40 may prevent damage to and contamination of the anti-reflection layer 100. The thickness of the anti-fingerprint layer 40 may be 18.4 nm to 21.6 nm.

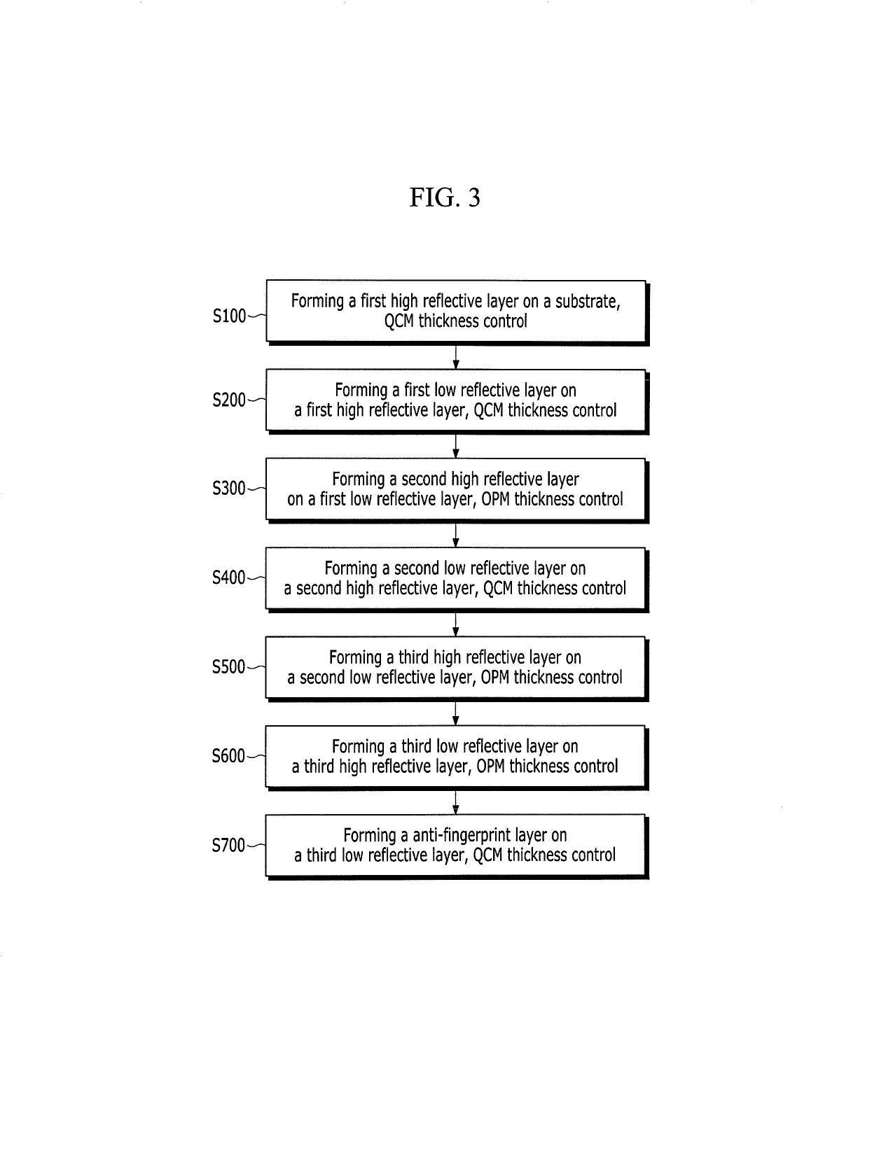

Next, a manufacturing method of the anti-reflective coating layer according to an embodiment will be described with reference to FIG. 3.

In a manufacturing method of the anti-reflective coating layer according to an embodiment, a plurality of high reflective layers and a plurality of low reflective layers are alternately deposited on the substrate 10 to form the anti-reflection layer 100. The thickness of the high reflective layer and the low reflective layer is controlled by selectively using a crystal thickness control method (quartz crystal monitoring, QCM) and an optical thickness control method (optical monitoring, OPM).

The crystal thickness control method (QCM) is relatively simple and electron beam speed control is possible. However, real-time monitoring may be difficult with the crystal thickness control method (QCM). As such, a defect rate may be increased and reproducibility of a thickness control may be low.

In contrast, the optical thickness control method (OPM) measures optical thickness (nd) (where n designates a refractive index of the high reflective layer and the low reflective layer, and d designates a physical thickness of the high reflective layer and the low reflective layer) to compensate for a value of a physical thickness due to a fine refractive index change inside the chamber in real time, such that reproducibility may be improved.

When forming the high reflective layer and the low reflective layer, real-time monitoring is possible. As such, an analysis of a cause of wavelength change and a subsequent treatment may be expedited.

The crystal thickness control method (QCM) may not measure a change in real-time of the optical thickness. As such, a defect of the anti-reflective coating layer may be determined after all manufacturing processes of the anti-reflective coating layer are finished and the thickness of the anti-reflective coating layer is measured. The optical thickness control method (OPM), however, monitors a formation process of any one layer, e.g., one or more of the layers, during the manufacturing processes of the anti-reflective coating layer in real time such that the optical thickness (nd) is measured in real time. Consequently, unnecessary manufacturing processes subsequent to an occurrence of the defect may be prevented in advance, such that time and cost may be reduced.

However, the optical thickness control method (OPM) is relatively complicated, the control of the electron beam speed may be difficult, and monitoring of the thin film may be difficult.

Accordingly, in the manufacturing method of the anti-reflective coating layer according to an embodiment, the crystal thickness control method (QCM) and the optical thickness control method (OPM) are selected according to the thickness of the high reflective layer and the low reflective layer to be formed. As such, uniform thickness may be achieved that is within the designated thickness range throughout an entire region of the high reflective layer and low reflective layer.

The high reflective layer or the low reflective layer is controlled by the optical thickness control method (OPM) when the high reflective layer or the low reflective layer is to have a thickness of more than λₚ/4n (where λₚ designates a reference wavelength of a control light irradiated for the optical thickness control method (OPM), n designates a refractive index of the high reflective layer or the low reflective layer, and d designates a physical thickness of the high reflective layer or the low reflective layer).

When the thickness of the high reflective layer or the low reflective layer controlled by the optical thickness control method (OPM) is less than λₚ/4n, a turning point may not be generated for the reference wavelength (λₚ) of the control light, such that reliability for the thickness measurement may be deteriorated.

Also, the reference wavelength (λₚ) of the control light may be determined by the following equation: λₚ=nd. If the refractive index (n) of the high reflective layer or the low reflective layer is changed, the physical thickness (d) of the high reflective layer or the low reflective layer is also changed. Similarly, a thickness (d) of the high reflective layer or the low reflective layer that is suitable for use in the optical thickness control method (OPM) is changed according to the refractive index (n) of the high reflective layer or the low reflective layer.

Accordingly, in the case of the first high reflective layer 20a, the second high reflective layer 20b, and the third high reflective layer 20c including the high reflective material with the refractive index more than 1.9, the optical thickness control method (OPM) is used when controlling a thickness of more than 51 nm by using the control light having the reference wavelength (λₚ) of 430 nm. The crystal thickness control method (QCM) is used when controlling a thickness of less than 51 nm.

Also, in the case of the first low reflective layer 30a, the second low reflective layer 30b, and the third low reflective layer 30c including the low reflective material having a refractive index less than 1.6, the optical thickness control method (OPM) is used when controlling a thickness of more than 73 nm by using the control light having a reference wavelength (λₚ) of 430 nm. The crystal thickness control method (QCM) is used when controlling a thickness of less than 73 nm.

As shown in FIG. 3, a transparent substrate 10 is positioned inside a vacuum depositor. Next, the first high reflective layer 20a is formed on the substrate 10. For example, an IV-H (goods name, manufactured by DON CO, LTD) high reflective material may be used as the first high reflective layer 20a. The IV-H (goods name) is a solid solution material manufactured by mixing, processing, and heat-treating the titanium oxide and the lanthanum oxide, and is a material having a high refractive index. In general, in the case of the high reflective material, the refractive index thereof may be changed under continuous deposition. However, the change of the refractive index of the above-described material is very slight. The thickness of the first high reflective layer 20a is controlled by the crystal thickness control method (QCM) to form a thickness of 14.9 nm to 17.5 nm (S100).

Next, the first low reflective layer 30a is formed on the first high reflective layer 20a. For example, an IV-L (goods name, manufactured by DON CO, LTD) may be used as the first low reflective layer 30a. The IV-L (goods name) is a material made of silicon dioxide at more than 99.9% that is referred to as fused silica and is not crystallized. The material is mainly melted and evaporated in an electron beam and is formed at a surface of a coating target, and reflection of the electron beam is suppressed by polishing the surface so as to suppress scattering of the electron beam that may be generated while melting or generation of fine particles such that uniformity while coating may be improved, and an influence by the fine particles may be minimized. The thickness of the first low reflective layer 30a is controlled by the crystal thickness control method (QCM) to form a thickness of 31.9 nm to 37.5 nm (S200).

Next, the second high reflective layer 20b as the IV-H (goods name) high reflective material is formed on the first low reflective layer 30a with a thickness of 56.5 nm to 66.3 nm (S300). The second high reflective layer 20b, having a refractive index of more than 1.9 and a thickness of more than 51 nm as λₚ/4n, may be controlled by the optical thickness control method (OPM) by using the control light having the reference wavelength (λₚ) of 430 nm.

The optical thickness control method (OPM) measures the optical thickness (nd) in real time to accurately control the thickness of the second high reflective layer 20b, such that the thickness of the entire region of the second high reflective layer 20b is uniform. Consequently, the refractive index of the entire region may be uniform.

Next, the second low reflective layer 30b as the IV-L (goods name) low reflective material is formed on the second high reflective layer 20b. The thickness of the second low reflective layer 30b is controlled by the crystal thickness control method (QCM) to form the thickness of 8.6 nm to 10.2 nm (S400).

Next, the third high reflective layer 20c as the IV-H (goods name) high reflective material is formed on the second low reflective layer 30b with the thickness of 51.4 nm to 60.4 nm (S500). The third high reflective layer 20c, having a refractive index of more than 1.9 and a thickness of more than 51 nm as λₚ/4n, may be controlled by using the control light having the reference wavelength (λₚ) of 430 nm by the optical thickness control method (OPM).

The optical thickness control method (OPM) measures the optical thickness (nd) in real time to accurately control the thickness of the third high reflective layer 20c such that the thickness of the third high reflective layer 20c is uniform, and thereby the refractive index of the entire region may be uniform.

Next, the third low reflective layer 30c as the IV-L (goods name) low reflective material is formed on the third high reflective layer 20c with the thickness of 80.0 nm to 94.0 nm (S600). The third low reflective layer 30c, having a refractive index of less than 1.6 and a thickness of more than 73 nm as λₚ/4n, may be controlled by the optical thickness control method (OPM) by using the control light having the reference wavelength (λₚ) of 430 nm.

The optical thickness control method (OPM) measures the optical thickness (nd) in real time to accurately control the thickness of the third low reflective layer 30c such that the thickness of the entire region of the third low reflective layer 30c is uniform. Consequently, the refractive index of the entire region may be uniform.

Next, the anti-fingerprint layer 40 as an IV-AF (goods name, manufactured by DON CO, LTD) anti-fingerprint material is formed on the third low reflective layer 30c. The thickness of the anti-fingerprint layer 40 is controlled by the crystal thickness control method (QCM) to form the thickness of 18.4 nm to 21.6 nm (S700).

As described above, when a plurality of high reflective layers and a plurality of low reflective layers are alternately deposited to form the anti-reflection layer 100, the thickness of the high reflective layer and the low reflective layer is controlled by selectively using the crystal thickness control method (QCM) and the optical thickness control method (OPM) such that the high reflective layers and the low reflective layers may be continuously formed with a uniform thickness that is within the designated thickness range. Consequently, excellent quality and improved productivity may be achieved.

Table 1 shows a material, a thickness, and a thickness control method of each layer according to the manufacturing method of the anti-reflective coating layer according to an embodiment.

TABLE 1

| | Layer | | | | | | |
|---|---|---|---|---|---|---|---|
| | 1st | 2nd | 3rd | 4th | 5th | 6th | 7th |
| | layer | layer | layer | layer | layer | layer | layer |
| Material name | IV-H | IV-L | IV-H | IV-L | IV-H | IV-L | IV-AF |
| (goods name) | | | | | | | |
| Thickness (nm) | 16.2 | 34.7 | 61.4 | 9.4 | 55.9 | 87.0 | 20.0 |
| Thickness | QCM | QCM | OPM | QCM | OPM | OPM | QCM |
| control method | | | | | | | |

A range of the thickness of each layer is set up within an 8% error range with reference to a thickness in Table 1 having the ensured reproducibility.

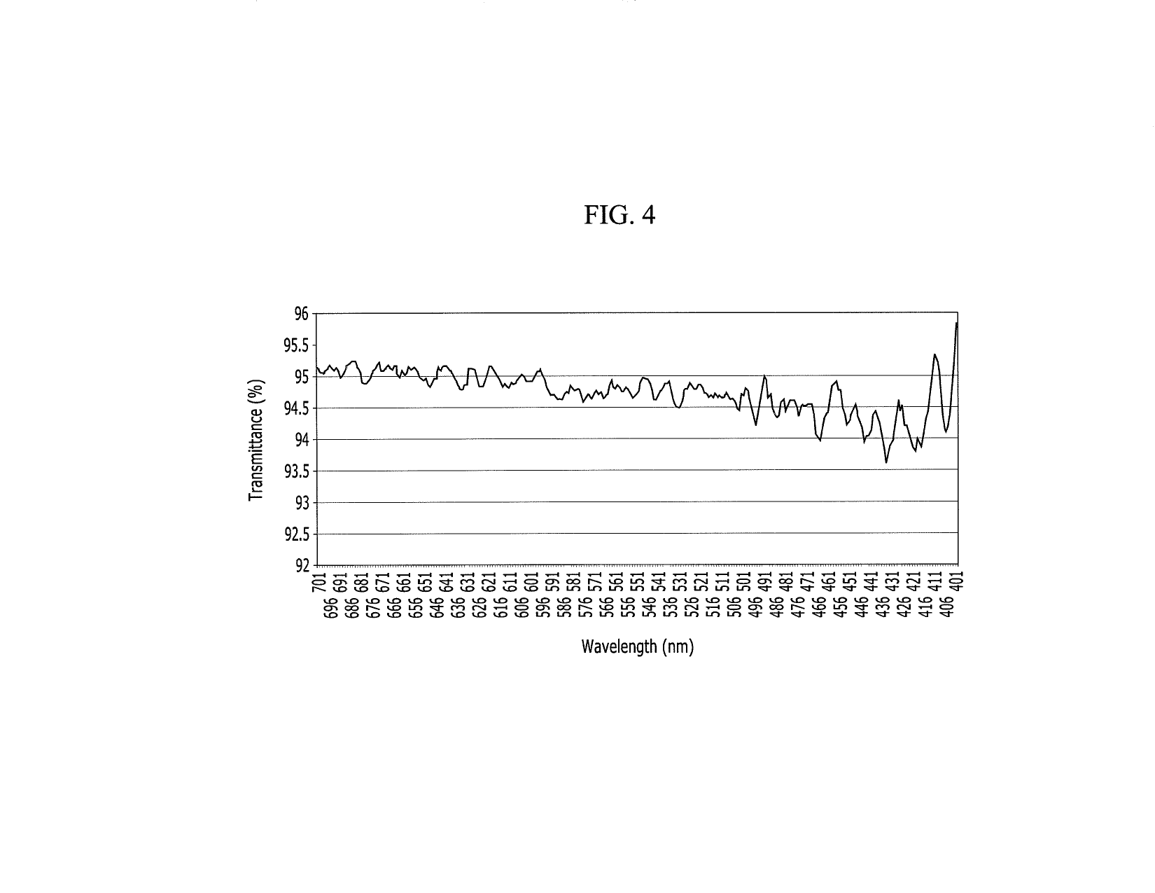

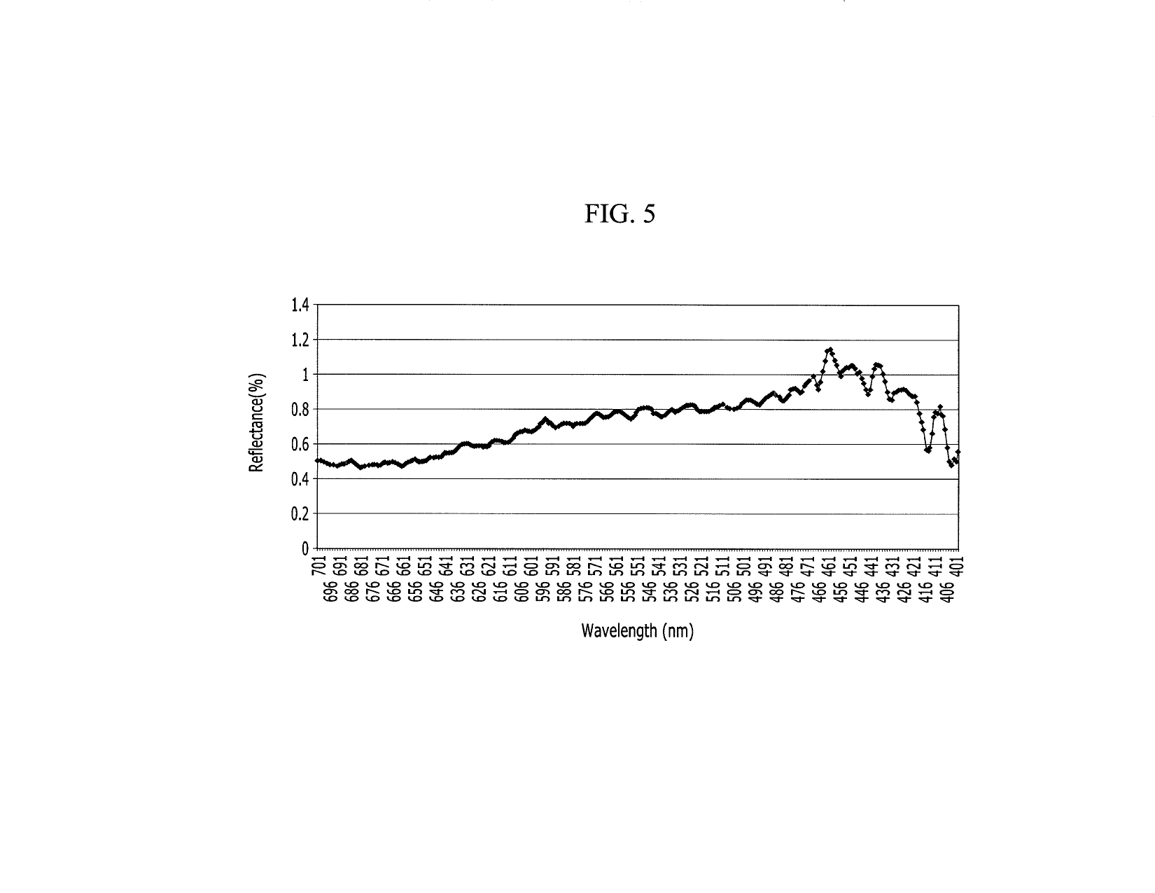

FIG. 4 is a transmittance graph of an anti-reflective coating layer according to an exemplary embodiment and FIG. 5 is a reflectance graph of an anti-reflective coating layer according to an exemplary embodiment. FIGS. 4 and 5 respectively are the transmittance graph and the reflectance graph measuring the anti-reflective coating layer manufactured according to the manufacturing method of the anti-reflective coating layer according to an exemplary embodiment shown in Table 1 in a visible ray wavelength region of 400 nm to 700 nm through a spectrophotometer U-4100 (model name) of HITACHI.

As shown in FIG. 4 and FIG. 5, the light transmittance of the anti-reflective coating layer according to an embodiment is about 95% in the visible ray region and the reflectance is less than 1.2%. As such, a significant amount of light is transmitted and reflectance is simultaneously minimized.

By way of summation and review, an anti-reflective coating layer may be used that increases light transmittance. The anti-reflective coating layer may be applied by various coating methods that are suitable for various materials. An anti-reflective coating layer may generally have an arbitrary color caused by surface reflection, and it may be generally difficult to achieve an anti-reflective coating layer without color. Further, it is also generally difficult to manufacture an anti-reflective coating layer without color. As a result, production of such an anti-reflective coating layer may be low, which may make commercialization difficult.

In the anti-reflective coating layer according to an embodiment, the refractive index of the entire region of the anti-reflection layer for each layer may be uniform, such that the reflectance of the anti-reflective coating layer may be uniform in the desired wavelength region, and thereby the anti-reflective coating layer may realize transparent non-chromaticity without a color. Thus, the anti-reflective coating layer according to an embodiment may be a transparent coating layer with non-chromaticity without an arbitrary color. Reflectance may be minimized in the anti-reflective coating layer according to the embodiment, such that distortion due to color or reflection may be prevented, and readability may be improved both indoors and outdoors.

Also, when the anti-reflective coating layer according to an exemplary embodiment is attached to a display device, sufficient visibility may be provided at low luminance. As such, an amount of power consumption of the battery may be reduced, and the display device may, thereby, be used for a long time. Accordingly, the display device with the anti-reflective coating layer according to an embodiment may be economical and environmentally friendly, and may provide increased convenience to a user relative to a general display device.

Furthermore, when a plurality of high reflective layers and a plurality of low reflective layers are alternately disposed to form the anti-reflection layer, the thickness of the high reflective layer and the low reflective layer may be controlled by selectively using the crystal thickness control method (QCM) and the optical thickness control method (OPM). As such, the high reflective layers and the low reflective layers may be continuously formed with uniform thickness. Excellent quality and improved productivity may also be achieved.

While this disclosure has been described in connection with what is presently considered to be practical exemplary embodiments, it is to be understood that the embodiments are not limited to the disclosed embodiments, but, on the contrary, are intended to cover various modifications and equivalent arrangements included within the spirit and scope of the appended claims.

What is claimed is:

1. An anti-reflective coating layer with transparent non-chromaticity, comprising:
a substrate; and
an anti-reflection layer, the anti-reflection layer including a plurality of high reflective layers and a plurality of low reflective layers alternately disposed on the substrate, a reflectance of the anti-reflection layer being 0.01% to 1.2% throughout a wavelength range of visible ray.

2. The anti-reflective coating layer of claim 1, wherein the plurality of high reflective layers and the plurality of low reflective layers alternately disposed on the substrate include:
a first high reflective layer on the substrate,
a first low reflective layer on the first high reflective layer,
a second high reflective layer on the first low reflective layer,
a second low reflective layer on the second high reflective layer,
a third high reflective layer on the second low reflective layer, and
a third low reflective layer on the third high reflective layer.

3. The anti-reflective coating layer of claim 2, wherein a thickness of the first high reflective layer is 14.9 nm to 17.5 nm, a thickness of the first low reflective layer is 31.9 nm to 37.5 nm, a thickness of the second high reflective layer is 56.5 nm to 66.3 nm, a thickness of the second low reflective layer is 8.6 nm to 10.2 nm, a thickness of the third high reflective layer is 51.4 nm to 60.4 nm, and a thickness of the third low reflective layer is 80.0 nm to 94.0 nm.

4. The anti-reflective coating layer of claim 2, wherein the first high reflective layer, the second high reflective layer, and the third high reflective layer have a refractive index of more than 1.9.

5. The anti-reflective coating layer of claim 2, wherein the first high reflective layer, the second high reflective layer, and the third high reflective layer include titanium oxide and lanthanum oxide.

6. The anti-reflective coating layer of claim 2, wherein the first low reflective layer, the second low reflective layer, and the third low reflective layer have a refractive index of less than 1.6.

7. The anti-reflective coating layer of claim 2, wherein the first low reflective layer, the second low reflective layer, and the third low reflective layer include silicon dioxide.

8. The anti-reflective coating layer of claim 2, further comprising an anti-fingerprint layer on the third low reflective layer.

9. The anti-reflective coating layer of claim 8, wherein a thickness of the anti-fingerprint layer is 18.4 nm to 21.6 nm.

10. A method of manufacturing an anti-reflective coating layer, the method comprising:
forming an anti-reflection layer by alternately depositing a plurality of high reflective layers and a plurality of low reflective layers on a substrate; and
controlling a thickness of the high reflective layers and the low reflective layers by selectively using a crystal thickness control method (QCM) and an optical thickness control method (OPM).

11. The method of claim 10, wherein alternately depositing the plurality of high reflective layers and the plurality of low reflective layers on the substrate includes:
forming a first high reflective layer on the substrate,
forming a first low reflective layer on the first high reflective layer,
forming a second high reflective layer on the first low reflective layer,
forming a second low reflective layer on the second high reflective layer,
forming a third high reflective layer on the second low reflective layer, and
forming a third low reflective layer on the third high reflective layer.

12. The method of claim 11, wherein controlling the thickness of the high reflective layers and the low reflective layers includes using the optical thickness control method (OPM) to maintain a thickness of more than λₚ/4n in the high reflective layer or a thickness of more than λp/4n in the low reflective layer, where λₚ=a reference wavelength of a control light irradiated in the optical thickness control method (OPM), and n=a refractive index of the high reflective layer or the low reflective layer.

13. The method of claim 12, wherein the crystal thickness control method (QCM) is used to maintain a thickness of less than λₚ/4n in the high reflective layer or the low reflective layer.

14. The method of claim 13, wherein the thickness of the first high reflective layer is 14.9 nm to 17.5 nm, the thickness of the first low reflective layer is 31.9 nm to 37.5 nm, the thickness of the second high reflective layer is 56.5 nm to 66.3 nm, the thickness of the second low reflective layer is 8.6 nm to 10.2 nm, the thickness of the third high reflective layer is 51.4 nm to 60.4 nm, and the thickness of the third low reflective layer is 80.0 nm to 94.0 nm.

15. The method of claim 14, wherein:
the optical thickness control method (OPM) is used to maintain a thickness of more than 51 nm in the high reflective layer when the reference wavelength is 430 nm, and
the crystal thickness control method (QCM) is used to maintain a thickness of less than 51 nm in the high reflective layer when the reference wavelength is 430 nm.

16. The method of claim 15, wherein:
the optical thickness control method (OPM) is used to maintain a thickness of more than 73 nm in the low reflective layer when the reference wavelength is 430 nm, and
the crystal thickness control method (QCM) is used to maintain a thickness of less than 73 nm in the low reflective layer when the reference wavelength is 430 nm.

17. The method of claim 16, wherein the thicknesses of the first high reflective layer, the first low reflective layer, and the second low reflective layer are controlled by the crystal thickness control method (QCM), and the thicknesses of the second high reflective layer, the third high reflective layer, and the third low reflective layer are controlled by the optical thickness control method (OPM).

18. The method of claim 12, further comprising forming an anti-fingerprint layer on the third low reflective layer.

19. The method of claim 18, wherein the anti-fingerprint layer is formed with a thickness of 18.4 nm to 21.6 nm.

20. The method of claim 19, wherein the thickness of the anti-fingerprint layer is controlled by the crystal thickness control method (QCM).
